(19) United States
(12) Patent Application Publication
(10) Pub. No.: US 2008/0279322 A1
(43) Pub. Date: Nov. 13, 2008

(54) Method and device for timing synchronization and neighbor scanning for cellular OFDM systems

(75) Inventors: Bogdan Franovici, Bucarest (RO); Emmanuel Lemois, Paris (FR)

Correspondence Address: GRAYBEAL, JACKSON, HALEY LLP, 155 - 108TH AVENUE NE, SUITE 350, BELLEVUE, WA, 98004-5973, US

(73) Assignee: SEQUANS COMMUNICATIONS, PARIS LA DEFENSE CEDEX (FR)

(21) Appl. No.: 12/069,022

(22) Filed: Feb. 5, 2008

(30) Foreign Application Priority Data
Feb. 5, 2007 (EP) 07290144.0

(51) Int. Cl. H04L 7/00

(52) U.S. Cl. 375/371

(57) ABSTRACT

An embodiment of a device for processing at least an incoming signal in a wireless communication system, said incoming signal being sent by a base station and comprising successive frames, each of which comprising at least a training symbol correlated to said base station, and a data symbol carrying message data.

The device comprises at least:
a first module digitizing and sampling the incoming signal;
a second module demodulating said digitized and sampled incoming signal, and generating a corresponding frequency domain symbol;
a timing synchronization and scanning module suitable for detecting at least a time offset of said training symbol by using said corresponding frequency domain symbol; and
a timing post processing module for processing said timing offset and for generating an improved timing offset used to start the sampling of following incoming signal.

### PRIORITY CLAIM

This application claims priority from European patent application No. 07290144,0, filed Feb. 5, 2007, which is incorporated herein by reference.

### TECHNICAL FIELD

An embodiment of the present invention relates generally to wireless communication systems, using transmission techniques like OFDM (Orthogonal Frequency Division Multiplexing) or OFDMA (Orthogonal Frequency Division Multiple Access), and more particularly to a set of techniques for timing synchronization and neighbor scanning in OFDM cellular systems.

More precisely, a first embodiment relates to a device for processing an incoming signal in a wireless communication system, said incoming signal being sent by a base station and comprising successive frames, each of which comprising at least a training symbol or preamble correlated to said base station, and a data symbol carrying message data.

### BACKGROUND

Orthogonal Frequency Division Multiplexing (OFDM) is a transmission technique, where a data stream is multiplexed over multiple orthogonal subcarriers, yielding a longer symbol period which may be advantageous in multipath conditions. Orthogonal Frequency Division Multiple Access (OFDMA) is a variant of OFDM, where the available spectrum is used simultaneously by multiple users which are using different orthogonal subcarriers.

OFDM generally decreases the Inter-Symbol Interference (ISI) by inserting a guard interval (GI) between OFDM symbols in order to maintain the orthogonality between the subcarriers, the guard interval being generally longer than the maximum delay spread of a channel.

Timing synchronization between a transmitter and a receiver is obtained to maintain the orthogonality between the subcarriers and thus enabling proper demodulation of the data.

For cellular mobile applications for instance, different requirements may be very important, among which:

First, at the mobile station (MS) side, a permanent knowledge of the network topology is available (serving base station (SBS), neighbor base stations (NBS), the associated signal quality measurements), which is accomplished through scanning. Thus, if the neighbor base stations and their signal quality are known, the mobile station is able to choose a serving base station by performing handover, with the purpose of either avoiding service interruption (for example when the signal quality from the serving base station becomes poor) or selecting a neighbor base station which gives a better signal quality and hence a higher data rate. The mobile station is required to do so in pedestrian environment as well as in vehicular environment. Scanning includes in searching for sequences matching known sequences transmitted by the base station referred to as preamble sequences. The scanning can be directed by neighbor advertising (i.e. the set of preambles the mobile station should search for is advertised by the serving base station) or autonomous (no a priori knowledge of the preamble to search for, so all preamble sequences are scanned). A major difference between single cell (typically fixed) and cellular (typically mobile) networks is that in the latter there are multiple preamble sequences in order to discriminate between multiple base stations.

Second, the mobile applications may have low power consumption to allow portable terminals with reasonable battery autonomy, which directly translates to low complexity algorithms. Furthermore, it is desired that the aforementioned scanning be done quickly and preferably during data reception, minimizing the need for special scanning intervals, and hence allowing the MS to sleep more in order to conserve its power.

In addition, a reasonable time for power-up to operational state (in the order of seconds) may be desired. Also related to this, when service interruption occurs due to very harsh conditions, a quick recovery may be desired.

There is little or no literature on scanning for OFDM or OFDMA cellular systems. The existing solutions for timing synchronization in OFDM or OFDMA cover single-cell point-to-point or point-to-multipoint systems without the need for handover and neighbor scanning. In all of them, there is a unique training sequence (which can consist of multiple training symbols called preambles), and therefore only a time domain search is performed, and sometimes extended to also cover frequency uncertainty by hypothesis or by other means.

Among the existing solutions, one known technique is the frequency domain cross-correlation consisting in applying a Fast Fourier Transform (FFT) to the receive samples, multiplying the FFT output by the inverse of the preamble sequence in the frequency domain, and translating back to the time domain using an IFFT. The Frequency domain cross-correlation yields a discontinuity at the FFT symbol edges which is commonly overcome using the so-called overlap-add or overlap-save FFT de-convolutions that yield extra complexity. In all cases, only one correlation result per input sample is required, which may be good enough for single cell systems because there is a unique well-known preamble to search. With this solution, part of the processing (FFT) is shared between several preamble hypotheses and correlation results can be very efficiently processed by using an IFFT to yield the channel impulse response for an expected preamble sequence. However, the overlap-add or overlap-save FFT de-convolution may still be either too complex or too slow, especially because the computation of the correlation result per NFFT (nominal FFT size for the OFDM system) input samples requires an FFT of order greater than NFFT on one side, for each sequence searched multiplication with the inverse of the frequency domain known sequence padded with zeros and again, for each sequence searched an IFFT of order greater than NFFT to get the channel impulse response.

### SUMMARY

Other techniques assume a rough synchronization point is known, but what is really needed and what will be described further is a comprehensive set of methods and algorithms to fulfill the requirements of a cellular system.

For this purpose, an embodiment of the invention provides a device that comprises at least:

a first module digitizing and sampling the incoming signal;

a second module demodulating said digitized and sampled incoming signal, and generating a corresponding frequency domain symbol;

a timing synchronization and scanning module suitable for detecting at least a time offset of said training symbol by using said corresponding frequency domain symbol; and

a timing post processing module for processing said timing offset and for generating an improved timing offset used to start the sampling of following incoming signal.

The timing synchronization and scanning module may be further suitable to provide one or more signal quality measurements of said training symbol, for example signal power, or noise plus interference power.

The device may further comprise a control module suitable for sending at least a command to the timing synchronization and scanning module via a command interface, and receiving at least a processing result from the timing synchronization and scanning module via a statistics interface in response to said command.

The incoming signal being for example an OFDM signal type and the training symbol being a well-known training symbol, also called a preamble.

The second module may implement means of a discrete Fourier transform, said means of a discrete Fourier transform are for example means of fast Fourier transform.

The timing offset may be processed by averaging, filtering or any other means reducing synchronization errors.

The timing synchronization and scanning module may be suitable for processing, based on commands from a control module, a plurality of training symbols sent at least by a serving base station and a neighbor base station, and providing timing offset and signal quality measurement of each training symbol to the control module, only the timing offset corresponding to the training symbol correlated to the serving base station are sent to the timing post processing module.

The training symbol is for example sent by different bases stations in neighbour cells.

The timing synchronization and scanning module may further process a plurality of successive frequency domain symbols, based on commands from the control module.

Thus the detection interval may be extended.

The timing synchronization and scanning module may comprises at least:

a frequency domain correlation module controlled by the control module, for computing and generating at least a channel impulse response based at least on the frequency domain symbol corresponding to said training symbol correlated to the serving base station;
a preamble processing module for determining if a specific preamble is present in said incoming signal, for generating a detection decision and for estimating the timing offset;
a statistic processing module for sending at least the detection decision, and the timing offset to said control module, and for sending said timing offset of said training symbol corresponding to said serving base station to the timing post processing module.

The preamble processing module may also provide the signal quality measurement.

The statistic processing module (13) may also send the signal quality measurement.

For example, the frequency domain correlation module comprises at least:

a look-up table module containing at least an inverse of a preamble,
a deconvolution module multiplying the frequency domain symbol with the inverse of the preamble as generated by the look up table,
a third module transforming the result of the multiplication in time domain,
a windowing module multiplying the result of the deconvolution module (115) with a windowing function to eliminate the distortions caused by discontinuities.

The windowing module may be placed anywhere on the data path as long as it is in the frequency domain.

The frequency domain correlation module may further comprise:

a decimation module for receiving a said incoming signal, and for generating, if needed, of a decimated version of the incoming signal, it may also be used to insert a frequency offset by using decimation offset.
a multipage memory for temporary storing one or more decimated versions of one or more frequency domain symbols,
a look-up table module containing at least a list of inverses of preambles, as indicated by the control module as an index in a pool of preambles,
a third module transforming the result of the multiplication in time domain, using for example an inverse Fourier transform,
a scheduler module for translating the commands sent by the control module into local control signals (e.g. decimation offset and decimation factor for the decimation module, control signal for the multipage memory, index of the preamble for the Look-up table).

For example, the preamble processing module comprises at least:

a discriminator suitable for differentiating between the useful part of the input channel impulse response and a noise floor, and for outputting a discriminated channel impulse response,
means for computing a timing offset from the discriminated channel impulse response.

The said preamble post processing module may comprise further a means of computing signal quality indicators.

For example, the discriminator compares the signal power to a predetermined threshold and interpreting the samples above the threshold as a useful signal, and by zeroing the samples below the threshold, considered noise and interference.

The preamble processing module is further capable of jointly processing at least two channel impulse responses corresponding to at least two successive symbols.

The preamble processing module is further capable to compute a metric for each of the two discriminated channel impulse responses corresponding to successive symbols, for instance the signal power.

The preamble processing module can select and discriminate the useful taps for both channel impulse responses by using the discriminated channel impulse response and the highest metric amongst the two metrics.

The preamble processing module may further combine coherently the channel impulse responses for the two symbols by using their constant phase relationship.

The timing offset may be computed as an average delay of the discriminated channel impulse responses.

The average delay of the discriminated channel impulse response CIR may be computed as follows:

computing a sum of the product of power of discriminated channel impulse response by said variable delay;
computing a sum of the power for the corresponding delay; and
computing a division of previously computed measures.

The timing synchronization and scanning module may further comprise a preamble post processing module refining the results of the preamble processing module from two consecutive training symbols in order to correct the ambiguity in timing offset and the error in signal quality measurements.

The preamble post processing module may be based on useful signal power on the two consecutive symbols to determine the error in timing offset and signal quality measurements, by look-up tables or equivalent means.

The detection interval for the timing offset may be limited to a predetermined or known interval and thus may increase the reliability of the detection.

A limited number of consecutive samples may be used for determining the timing offset.

The statistics processing module may also be used to find the best match for a preamble when the detection interval is a plurality of symbols by performing a maximum search, for example on power of the discriminated channel impulse symbol. The statistics processing module may be used in such a way that only the statistics for the best match are provided to the control module.

The statistics processing module may be used to filter the results by invalidating the detections for certain preambles, for instance if the timing offset is too high.

An embodiment of the proposed device operates at the output of the Fast Fourier Transform module, on the extracted for demodulation (groups of N samples representing the FFT of the N-sample data symbols separated by guard intervals). Hence, the scanning may be performed seamlessly during normal data reception.

Another embodiment of the invention is a method for implementing a device described above, in a timing tracking of a serving base station mode, comprising at least the steps of:

sending to the timing synchronization and scanning module at least:
an index of an expected preamble in said incoming signal, an index of a frequency domain symbol corresponding to the expected preamble, and
a decimation factor, and
a decimation offset,
said timing synchronization and scanning module executes the steps of:
generating a frequency domain symbol corresponding to said incoming signal,
detecting a time offset of said training symbol by using said frequency domain symbol,
sending a detection decision according to the expected preamble, and
sending said timing offset to said timing post processing module,
said timing post processing module executed the steps of:
generating an improved timing offset, and
establishing a sampling instant for following incoming signal.

The timing synchronization and scanning module may return to a control module, via a statistics interface, the detection decision, the timing offset, and the signal quality indicators, if available.

In a scanning for neighbor base stations in synchronous networks mode, the method may further comprise at least the steps of:

sending to the timing synchronization and scanning module at least:
a list of index of expected preambles in said incoming signal,
an index of a frequency domain symbol corresponding to the expected preambles,
a decimation factor, and
a decimation offset,
said timing synchronization and scanning module executes at least the steps of:
generating a frequency domain symbol corresponding to said incoming signal,
detecting timing offsets of said training symbols by using said frequency domain symbol,
providing at least a set, said set comprising at least:
an index of an expected preamble among the list of index of expected preambles,
a corresponding detection decision according to said expected preamble of the set,
a corresponding timing offset,

The timing synchronization and scanning module may return to the control module via the statistics interface one set for each of the preamble index in the list, a set comprising:

the preamble index,
the detection decision,
the timing offset, and
the signal quality indicators, if available.

In a scanning-for-neighbor-base-stations-in-synchronous-networks-with-large-cells mode, the method may further comprise at least the steps of:

sending to the timing synchronization and scanning module at least:
a list of index of expected preambles,
an index of the first frequency domain symbol where the preambles are going to be searched in the incoming signal,
a number of frequency domain symbols where the preambles are going to be searched in the incoming signal,
a decimation factor, and
a decimation offset,
the timing synchronization and scanning module executes at least the steps of:
generating frequency domain symbols corresponding to said incoming signal,
detecting timing offsets of said training symbols by using said frequency domain symbols,
providing at least a set, said set comprising at least:
an index of an expected preamble among the list of index of expected preambles,
a corresponding detection decision according to said expected preamble of the set,
a corresponding timing offset,

The timing synchronization and scanning module may return to the control module via the statistics interface one set for each of the preamble index in the list, a set comprising:

the preamble index,
the detection decision,
the timing offset, and
the signal quality indicators, if available.

In a scanning-for-neighbor-base-stations-in-asynchronous-networks mode, the number of frequency domain symbols where the preambles are going to be searched may be equal to or greater than the number of symbols in a frame.

The method may comprise a power up algorithm which comprises:

a cell search, by using the method in asynchronous networks mode, on all preambles in the network and in distinctive subsets,
an acquisition step: for the successful detections, the measurements are refined by using the method in synchronous networks with large cells mode, on the set of the preambles that yielded positive detections during cell search,
a tracking step: once a timing offset is refined, a preamble is chosen amongst the successful detections and the corresponding base station is chosen as a serving base station and the tracking is done using the method in a timing tracking of a serving base station mode,
the scanning may start immediately after the successful synchronization in order to find neighbour base stations

In all the modes described above the timing synchronization and scanning module may also comprise the following steps:

compute signal quality measurements,
another output is added to the set: a corresponding signal quality measurement according to an expected preamble of the set,

### BRIEF DESCRIPTION OF THE DRAWINGS

Features and advantages of one or more embodiments of the invention will appear more clearly from the description made hereinafter, as an indication and by no means restrictive, with reference to the accompanying drawings, wherein:

FIG. 1 shows a generic data communication system;

FIG. 2 shows a typical cellular system;

FIG. 3 illustrates an OFDM signal;

FIG. 4 presents the structure of an embodiment of a receiver comprising the device according to an example of embodiment of the invention; and

FIG. 5 shows a timing synchronization and scanning module 10 structure;

FIG. 6 shows a structure of a frequency domain correlation module according to an embodiment of the invention;

FIG. 7 shows a possible implementation of preamble processing module;

FIG. 8 shows a possible implementation of a preamble post-processing module;

FIG. 9 shows the capturing windows for tracking and for the different scanning modes; and

FIG. 10 shows the observation windows used for tracking and for the different scanning modes.

### DETAILED DESCRIPTION

An OFDM signal includes multiple signals, each modulating a subcarrier. It is known in the art that a fundamental parameter of an OFDM system is the FFT (Fast Fourier Transform) size, denoted by N, N being an integer, for example for an application N=1024. The sampling period is denoted by Ts, which is a system parameter chosen according to the bandwidth of the system. The data portion of an OFDM symbol includes N samples and its length is NTs.

It is also known in the art that a guard interval including NGI samples is inserted between successive OFDM symbols forming the OFDM signal in order to combat inter-symbol interference. Usually, in order to eliminate the self interference generated by the discontinuity, the guard interval contains a copy of the last NGI samples of the next data symbol and hence it is called a cyclic prefix.

As shown in FIG. 3, each data frame of a wireless system may include one or more training symbols such as for example preamble symbols, or pilot symbols. A preamble symbol may be a training symbol at the beginning of each data frame. Typically, the preamble symbol may be used for various synchronization tasks. A pilot symbol may be a training symbol to provide tracking information, which may be associated for example with a spatial channel.

In the frequency domain, the transmitted symbol is denoted by XN(k), which is a sequence of complex numbers which will modulate the subcarriers. In the time domain, after the cyclic prefix is appended, the baseband signal can be expressed as:

$$x ( t ) = {\sum }_{k = - \frac{N}{2} , … , \frac{N}{2} - 1} {X}_{N} ( k ) {e}^{j \frac{2 π k}{{NT}_{s}} t} , t ∈ [ - {N}_{G I} {T}_{s} , {NT}_{s} ]$$

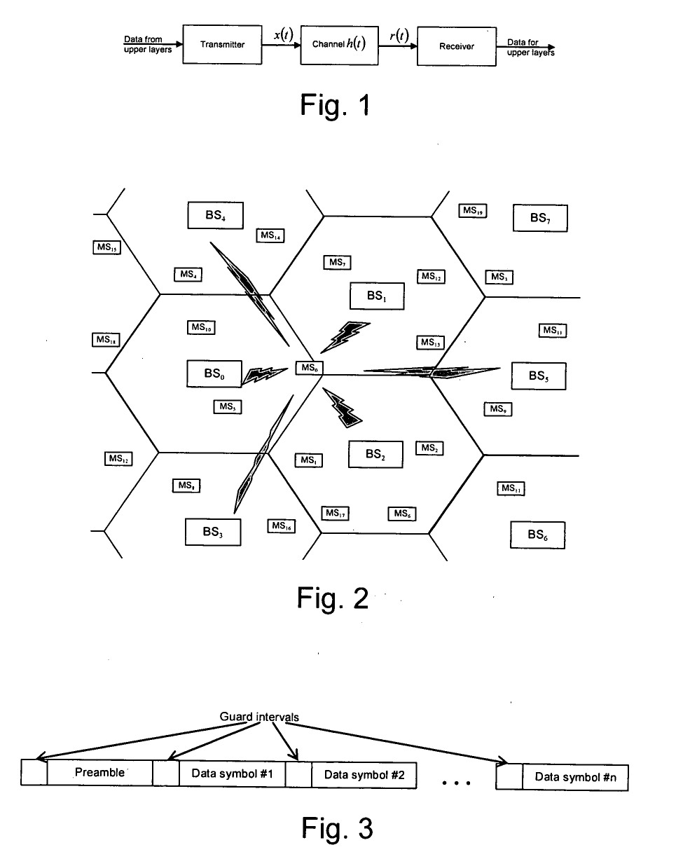

A generic data communication system is depicted in FIG. 1. It comprises a transmitter that converts upper layer data in an analog signal, a communication channel h(t), and a receiver which translates the received analog signal into data for upper layers.

The transmitted signal x(t) is altered by the communication channel. The channel impulse response for a multipath channel with Ntaps discrete propagation paths can be expressed as:

$$h ( t ) = {\sum }_{m = 1 , … , {N}_{taps}} {g}_{m} δ ( t - {τ}_{m} ) where \text{:}$$

gm is the gain for each tap (or propagation path)

δ is the Dirac impulse function

τm is the propagation delay for tap m

At the receiver side, the signal may be expressed as (the additive white noise is ignored for simplicity):

$$r ( t ) = x ( t ) ⊗ h ( t ) = {\sum }_{m = 1 , … , {N}_{taps}} {g}_{m} x ( t - {τ}_{m} )$$

A typical cellular system is depicted in FIG. 2, where BS stands for base station and MS stands for mobile station. It is known that an MS receives signals from multiple base stations, which may be harmful from interference point of view, but it may be beneficial in the sense that the MS may perform handover when said MS detects that the signal from a BS is better than the signal of the BS that the MS is currently communicating with (serving BS).

For example, the BS periodically sends a well-known or current training sequence referred to as preamble. In a cellular system, the preambles are different among neighbor base stations, they belong to a set of I preambles P_{N}ⁱ, i=0, . . . , I−1 and they are reused in the same manner as frequency is reused for classical TDMA cellular systems. Although a single preamble is considered in the equations, in reality the signal received is a combination of signals from multiple base stations each with its own preamble sequence.

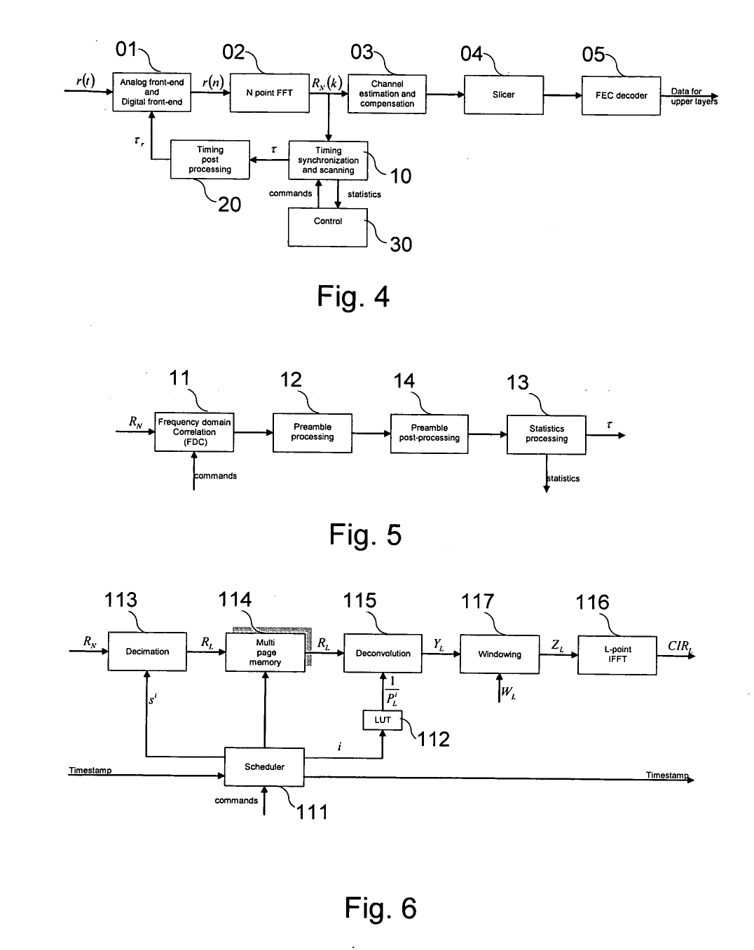

An embodiment of the present invention is depicted in FIG. 4, where the MS performs the following tasks: first, it finds the point in time where to start sampling the signal received from the serving base station for proper demodulation (or timing synchronization) and second, it scans for neighbor base stations in order to have a good picture of the timing offset and signal quality for serving base station and the neighbor base stations.

The analog signal, processed by an analog front-end and a digital front-end module 01 (for example an Analog to Digital converter), is converted to digital and sampled at a nominal sampling period:

r(n)=r(t)|_{t=nT}_{ₛ}+τ_{ᵣ}

The sampled signal r(n) will be further processed by means of a discrete Fourier transform 02, for example a fast Fourier transform (FFT). When all the reflections fall within the guard interval (no inter-symbol interference), the structure of the received symbol is, after performing the discrete Fourier transform:

$$\begin{matrix}{R}_{N} ( k ) = F F T \{ r ( n ) {\vert}_{n = 0 , … , N - 1} \} \\ = {X}_{N} ( k ) {\sum }_{m = 1 , … , {N}_{taps}} {g}_{m} {e}^{j \frac{2 π}{N} k \frac{( {τ}_{r} - {τ}_{m} )}{{T}_{s}}} ,\end{matrix}$$

$$k = - \frac{N}{2} , … , \frac{N}{2} - 1$$

The condition for reception with no inter-symbol interference is: 0<τₘ−τᵣ<N_{GI}Tₛ, m=1, . . . , Nₜₐₚₛ,

where τᵣ is the result of a timing post processing module 20 shown in FIG. 4, which processes, by averaging, filtering or any other means, the result of timing synchronization and scanning module 10. The parameter τᵣ is used to select the correct timing offset where the input signal is sampled, thus realizing the timing synchronization.

The timing synchronization and scanning module 10 may be used in two modes.

In a first operating mode, it will track a timing offset or delay r of the preamble of the serving base station (which will be referred as the current preamble or current training symbol) in order to properly demodulate the data. It will also gather the timing offset along with signal quality measurements (like for example received signal power and signal to interference plus noise ratio) and send them to a control module 30 (via a statistics channel).

In a second operating mode, under the supervision of the control module 30 which will send commands to the timing synchronization and scanning module 10 (via the command channel), the timing synchronization and scanning module 10 will scan other preambles in an attempt to find neighbor base stations. The timing offset of the preambles scanned along with signal quality measurements are provided back to the control entity via the statistics channel. The control entity can be autonomous or it can be directed by neighbor advertising (information about the neighbor base stations sent by the serving base station).

A distinctive feature of the proposed receiver is that the timing synchronization and scanning module operates at the output of a discrete Fourier transform module 02, on the symbols extracted for demodulation (groups of N samples representing the fast Fourier transform of the N-sample data symbols separated by guard intervals). Hence, the scanning may be performed seamlessly during normal data reception.

e rest of the modules depicted FIG. 4 is typical for an OFDM receiver. The complex channel coefficients are estimated and are compensated for in the received signal by the channel estimation and compensation module 03. The compensated signal is further processed by a slicer module 04 and a forward error correction decoder 05. Finally, the data is sent to upper layers.

Now let us explain an example of an embodiment of a first operating mode, also called tracking mode for steady-state timing tracking.

In the following, the timing synchronization and scanning module is described showing the functionality of each sub-module.

The structure of timing synchronization and scanning module 10 is depicted FIG. 5.

First, the output of the discrete Fourier transform 02 or N-point IFFT, denoted by R_{N}(k) is passed through a frequency domain correlation (FDC module) 11, which is controlled by the Control module 30 via the commands channel. The output of the FDC module 11 is a channel impulse response CIR for the specific preamble (or current training symbol) commanded by the control module (in the case of tracking the preamble is the current preamble, i.e. the preamble used by the serving BS). The channel impulse response CIR is further processed by a preamble processing module 12 to get estimates of the timing offset τ, a signal power as well as noise and interference power. The preamble processing module 12 also makes a decision if a specific preamble was present or not. The preamble post processing module 14 can be bypassed for tracking, and can be is used for example for combining the results of two successive OFDM symbols processed by other functions. A statistics processing module 13 may be used to send the detection of a specific preamble decision with the timing offset information and the signal quality measurement to the control module 30 via the statistics channel. The statistics processing module 13 may also be used to further filter results of the commanded operations. The timing offset τ of the current preamble will be provided to the timing post-processing module 20 for further processing to generate an improved estimate τᵣ used to start sampling by the analog front-end and digital front-end module 01, as explained above.

The structure of the Frequency domain correlation (FDC) module 11 is depicted in FIG. 6. A scheduler 111 is responsible of translating the commands from the control module 30 to local control signals and hence FDC module 11 may perform different functions under the supervision of the control module 30. For instance, the index of the preamble to be used in the correlation is input to a look-up table (LUT) 112 to get the needed preamble sequence. Also a decimation offset sⁱ corresponding to the same index is provided to a decimation module 113. Each N-sample block from the output of the N-point FFT 02 is provided to the synchronization and scanning module 10 along with a timestamp corresponding to the first sample of the block in the time domain. The scheduler 111 is used to control for example a multi-page memory 114 and also the processing for the purpose of accommodating different functions. For tracking, the output of the decimation module 113 may be directly sent to a de-convolution module 115. However, in order to cope with frequency offset uncertainty, an additional offset may be applied to the decimation module corresponding to frequency offset hypothesis (with granularity equal to the inter-carrier spacing). For a single FFT output and a single preamble index more de-convolutions may be performed, one for each frequency offset hypothesis. The preamble sequences may also modulate only a part of the subcarriers (denoted here by M), equally spaced at intervals of T subcarriers which will yield a T-times repetition of a sequence in the time domain. A subcarrier set chosen is selected by a decimation offset sⁱ=0, . . . , T−1. For the preferred application, M=284, T=3 and sⁱ=0, . . . , 2. The decimated frequency domain sequence is:

$${R}_{M} ( k ) = {R}_{N} ( T \cdot k + {s}^{i} ) = {P}_{M}^{i} ( k ) {\sum }_{m = 1 , … , {N}_{taps}} {g}_{m} {e}^{j \frac{2 π}{N} ( T \cdot k + {s}^{i} ) \frac{( {τ}_{r} - {τ}_{m} )}{{T}_{s}}} , \\ k = - \frac{M}{2} , … , \frac{M}{2} - 1$$

The decimation module 113 may be skipped if all of the subcarriers are used by the preamble (T=1) and when no frequency offset hypothesis are tested.

However, when extracting the carriers, the decimation offset may be allowed to take larger values in order to also incorporate frequency offset hypothesis in units of one subcarrier spacing. For instance, if hypothesis f_{hyp}=−3, . . . , 3 subcarrier spacing need to be tested, the decimation offset range is s_{hyp}ⁱ=−3, . . . , T+2

For an efficient implementation of discrete Fourier transform, a subset of L≦M subcarriers may be used further (a power of 2 for instance). Due to frequency offsets expected at the receiver, the part in the center of the spectrum is selected. However, a different choice may be imagined. For instance, in a preferred application only L=256 subcarriers will be used out of the M=284 modulated, for only a small performance loss.

$${R}_{L} ( k ) = {R}_{M} ( k ) = {P}_{L}^{i} ( k ) {\sum }_{m = 1 , … , {N}_{taps}} {g}_{m} {e}^{j \frac{2 π}{N} ( T \cdot k + {s}^{i} ) \frac{( {τ}_{r} - {τ}_{m} )}{{T}_{s}}} , \\ k = - \frac{L}{2} , … , \frac{L}{2} - 1$$

And after de-convolution with the expected preamble sequence we obtain (the other preambles, although not shown in the equation will be whitened along with all the interferers):

$${Y}_{L} ( k ) = \frac{{R}_{L} ( k )}{{P}_{L}^{i} ( k )} = {\sum }_{m = 1 , … , {N}_{taps}} {g}_{m} {e}^{j \frac{2 π}{N} ( T \cdot k + {s}^{i} ) \frac{( {τ}_{r} - {τ}_{m} )}{{T}_{s}}} , \\ k = - \frac{L}{2} , … , \frac{L}{2} - 1$$

The inverse of the preamble sequences

$$\frac{1}{{P}_{L}^{i} ( k )}$$

are generated by the look-up table (LUT) 112.

Further a means of inverse discrete Fourier transform module (or L-point IFFT module) 116 analyzes the content of Y_{L} which will give us an estimate of the channel impulse response (CIR_{L}). Prior to the L-point IFFT module, Y_{L} will be multiplied with a windowing 117 function W_{L} in order to remove the discontinuity at the edges of the transmitted spectrum (between Y_{L}(−L/2) and Y_{L}(L/2−1) for example).

The windowing 117 may be placed after the de-convolution module 115 or anywhere from the output of the N-point FFT module 117 to the input of the L-point IFFT module 116. The channel impulse response CIR_{L} is further analyzed by the preamble processing module 12, which functions are: first, to decide if the preamble is present, second to compute the timing offset τ, and third to compute signal quality measurement.

The input CIR_{L} is the channel impulse response, but it should be kept in mind that it is sampled with a sampling period equal to

$$\frac{N}{LT} {T}_{s}$$

in this embodiment.

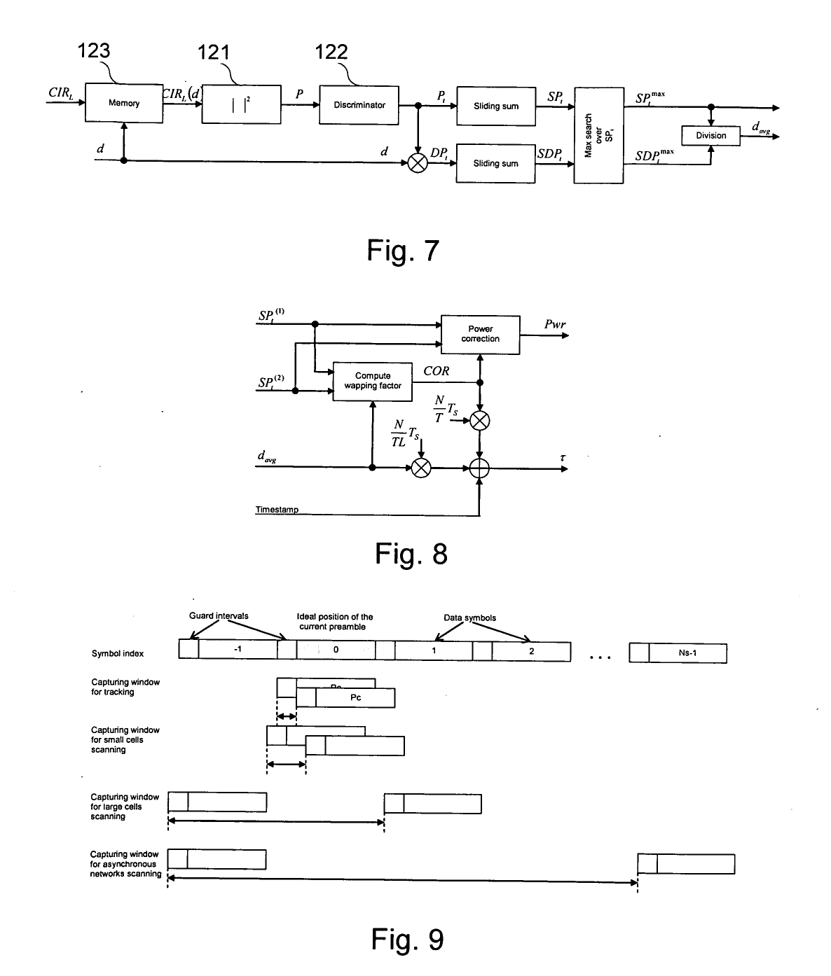

A possible implementation of preamble processing is depicted in FIG. 7. Those skilled in the art may imagine different implementations without departing from the spirit and scope of the present disclosure.

The delay d is used to index the CIR_{L}:

$$d = {d}_{offset} - \frac{L}{2} , … , {d}_{offset} + \frac{L}{2} - 1.$$

The interval of d may be restricted to a smaller interval centered around an expected bias d_{offset}, if the control entity decides to track the serving base station preamble in a smaller interval called tracking window. If there is no information on the expected bias of the timing offset, d_{offset} is set to zero.

The power of the CIR_{L} is then computed as P(d)=|CIR_{L}(d)|², by the power module 121. Further, a discrimination function is applied to separate the actual channel impulse response CIR from noise floor. A threshold function is applied by the discriminator 122 to the power of the CIR, where Pₜₕ is a power threshold (for example based on the calculated noise floor and depending on the needed false alarm/non-detection performance), and the result of the discrimination function is:

$${P}_{t} ( d ) = \{ \begin{matrix}P ( d ) & when P ( d ) \geq {P}_{th} \\ 0 & when P ( d ) < {P}_{th}\end{matrix}$$

The detection is successful if at least one value of Pₜ(d) is non-zero. Two sliding sums are used for Pₜ(d) and d·Pₜ(d) to measure in a wanted window referred to as summing window, typically equal to the guard interval length.

$${SP}_{t} ( n ) = {\sum }_{d ∈ n + < summing window >} {P}_{t} ( d )$$

$${SDP}_{t} ( n ) = {\sum }_{d ∈ n + < summing window >} d \cdot {P}_{t} ( d )$$

The measure nε<tracking window> is the center of the summing window chosen based on the expected variation of the channel impulse response.

The maximum value of SPₜ is kept (the CIR with the highest power in a window) as well as the corresponding SDPₜ. The average delay is computed by a simple division of the two values kept:

$${d}_{avg} = \frac{{SDP}_{t} ( {n}_{opt} )}{{SP}_{t} ( {n}_{opt} )} = \frac{{\sum }_{d ∈ {n}_{opt} + < window >} d \cdot {P}_{t} ( d )}{{\sum }_{d ∈ {n}_{opt} + < window >} {P}_{t} ( d )}$$

The timing offset detection is limited to the interval

$${d}_{avg} ∈ {d}_{offset} + [ - \frac{L}{2} , \frac{L}{2} - 1 ] .$$

However, if the tracking window and summing window are smaller, the detection will be limited to the tracking window plus the summing window and centered around the bias d_{offset}.

Although the average delay is presented as an example, different measurements are possible without departing from the spirit and scope of this disclosure.

The discriminated power of the channel impulse response Pₜ(d) is used to evaluate the power of the wanted signal.

For the noise plus interference power measurements, the measure before discrimination will be used. The samples outside the a priori known interval of expected time offsets may be used. For instance, assuming half of the CIR_{L} samples (the ones at the edges) contain noise floor only, the noise plus interference power spectral density may be estimated:

$${psd}_{N + I} = \frac{2}{L} \{ {\sum }_{d = {d}_{offset - [ \frac{L}{4} + 1 , … , \frac{L}{2} ]}} P ( d ) + {\sum }_{d = {d}_{offset + [ \frac{L}{4} , … , \frac{L}{2} - 1 ]}} P ( d ) \}$$

The same psd_{N+1} may be used in the discriminator (for instance Pₜₕ can be calculated as psd_{N+1} multiplied with a constant). Alternatively, the noise plus interference power measurements may be measured by subtracting the power of the discriminated signal from the total power.

For tracking, no corrections are performed in the Preamble post-processing module 14. The timing offset of the received preamble is computed as the sum of the timestamp at the beginning of the OFDM symbol analyzed and the measured offset with respect to the beginning of the symbol:

$$τ = Timestamp + {d}_{avg} \frac{N}{LT} {T}_{s}$$

The statistics processing module 13 may pack the detection decision with the timing information and the signal quality measurements (signal power, noise and interference power, signal to noise plus interference ratio, etc.) and send the information to the control module 30 via the statistics channel.

It may also be used to further filter the results of the commanded operations, for instance based on the calculated timing offset τ, a detection may be invalidated if the timing offset is too high, and it may be disregarded by the timing post-processing module. This way, the system may be more robust and it will stay locked even in harsh conditions. Those skilled in the art may imagine other criteria to invalidate the detection of the preamble.

In the sections above, it has been described how the proposed receiver performs timing synchronization and associated signal quality measurements, by processing the preamble sent by the serving base station.

However, another function of an embodiment of the proposed system is neighbor scanning, which translates into processing the received signal in an attempt to find the preamble sequences sent by the neighbor base stations and to measure the timing offset and signal quality indicators.

Now let's describe an embodiment of the second operating mode, also called scanning.

There may be two types of network deployment:

Synchronous (the base stations of the network are synchronized; they have the same frame size and the transmission time of the preambles fall into a limited and known time interval). In this case, the preambles of neighbor base stations are searched in a limited interval around the known position of the preamble of the serving base station.
Asynchronous (there is no relationship between the timings of different base stations). In this case the preambles of neighbor base stations are searched in the whole frame, as they may be anywhere.

For synchronous networks, two cases are considered:

Small cells: the timing difference due to the propagation delay is small enough and hence a single OFDM symbol is enough for the detection.
Large cells: the timing difference due to the propagation delay is large and the receiver processes more symbols centered around the preamble of the serving base station in order to detect the preambles of the neighbor base stations.

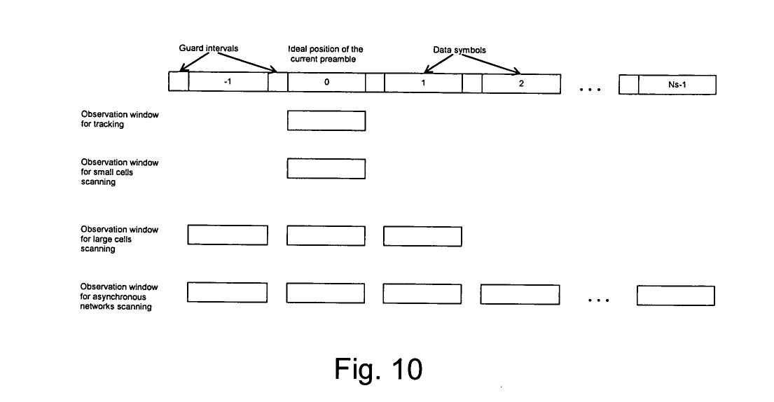

FIG. 9 shows the capturing windows (i.e. the timing offsets that are unambiguously detectable) for tracking and for the different scanning modes.

FIG. 10 shows the observation windows used for tracking and for the different scanning modes. The observation windows are N-sample windows in the time domain, sampled with the nominal sampling period Tₛ and separated by N_{GI} samples that are discarded. They are known in the art as FFT windows, since the N-tuples will be processed further by an N-point FFT module.

For large cells, scanning using for example three symbols was considered. However, those skilled in the art may choose a larger interval if the expected delay spread of the preambles in the network is larger.

For scanning for synchronous networks with small cells, the processing is similar to tracking (first operating mode) of the current preamble, with some differences which will be described in the following.

A major difference is in the scheduling and memory management. The control module 30 may request several preambles to be tested on the same FFT window. Moreover, the preambles may have different decimation offsets. In this case, the distinct decimated versions are stored in different pages of the multi-page memory, and they may be processed further without real-time constraints during the rest of the frame. For a given decimation offset all the preambles having that specific decimation offset may be tested.

It is desirable that the windowing is done prior to the de-convolution in order to do it once for all preambles using the same decimation offset.

For the preamble processing, the tracking and summing windows may be chosen in order to maximize the capturing window.

The scanning for synchronous networks with large cells is somewhat different: the N-point FFT results for all of the needed symbols are stored after decimation (three symbols in the example) in order to allow non-real time processing of many preamble sequences. In order to minimize the memory size, the group of preambles that are to be tested should have the same decimation offset.

However, other scheduling and storing mechanisms may be imagined, for instance if a small number of preambles are to be tested they may be processed in real time taking advantage of the reduced complexity (the complexity of an L-point IFFT is less than L/N the complexity of an N point FFT), using the memory as a buffer or as a FIFO (first in first out).

The preamble processing module may be modified in order to jointly process two adjacent OFDM symbols since the preamble may be anywhere in between symbols due to large delay spread.

If a preamble is part on the first symbol and part on the second symbol, the phase relationship between the CIR_{L} for the two symbols is known (depends on the length of the guard interval and the decimation offset). The known phase relationship might be used for coherent combining.

One way to modify the preamble processing is to separately run it for each of the two symbols, and then use the stronger of the two discriminated CIRs (Pᵢ⁽ⁱ⁾(d), i=1, 2) to select the taps for both CIRs:

$${P}_{t}^{( M )} ( d ) = \{ \begin{matrix}{P}_{t}^{( 1 )} ( d ) & if max \{ {SP}_{t}^{( 1 )} ( n ) \} > max \{ {SP}_{t}^{( 2 )} ( n ) \} \\ {P}_{t}^{( 2 )} ( d ) & otherwise\end{matrix} \\ {SP}_{t}^{( i )} ( n ) = {\sum }_{d ∈ n + < summing window >} {P}_{t}^{( i )} ( d ) , i = 1 , 2 \\ where \\ {P}_{t}^{combined} ( d ) = \{ \begin{matrix}{P}^{( 1 )} ( d ) + {P}^{( 2 )} ( d ) & when {P}_{t}^{( M )} ( d ) > 0 \\ 0 & when {P}_{t}^{( M )} ( d ) = 0\end{matrix}$$

The same sliding sum mechanism is used on the combined discriminated Pₜ^{combined}(d).

Those skilled in the art may imagine different ways to jointly process the two symbols, without departing from the spirit and scope of this disclosure.

There is also a deterministic amplitude relationship between the CIR_{L} for the two adjacent symbols, depending on the position of the preamble in the two symbols. The amplitude relationship may be used to solve the timing uncertainty due to the T-times repetition of the preamble (the preamble consists of T-times repetition of a sequence of length

$$\frac{N}{T} {T}_{s}$$

).

The preamble processing module 14 illustrated in FIG. 8 may have in this case a set of outputs for each pair of adjacent OFDM symbols.

The preamble post processing module may be used to remove the timing uncertainty based on the power of the two discriminated CIRs (the correction factor is an integer multiple of the length of the basic sequence repeated

$$\frac{N}{T} {T}_{s}$$

and is determined by look-up tables or threshold methods or any other means, as a function of timing offset and power of the two discriminated CIRs).

$$\begin{matrix}τ = Timestamp + {d}_{avg} \frac{N}{LT} {T}_{s} + COR \frac{N}{T} {T}_{s} \\ = Timestamp + ( {d}_{avg} + L \cdot COR ) \frac{N}{LT} {T}_{s}\end{matrix}$$

For the power statistics, another correction may be applied (the power is split between the two symbols). Again, the power correction factor is determined by look-up tables or threshold methods or any other means, as a function of timing offset and power of the two discriminated CIRs.

In the statistics processing module 13, a maximum search is performed on the partial results. For detection on K symbols (3 in our example), K−1 pairs of symbols are processed by the preamble processing module ({1,2}, {2,3}, . . . , {K−1,K}), hence K−1 sets of statistics are available, one for each pair processed. The K−1 results are further refined by the preamble post-processing module.

The statistics processing module first determines if a detection occurred (at least one of the K−1 results indicates a detection), then a maximum search is performed on the power measurement, and the other corresponding measurements are packed with the power measurement and sent to the control entity via the statistics channel. Conversely, all of the measurements may be provided to the control entity without filtering by maximum search. Moreover, only the measurements for the detections may be provided.

The processing for asynchronous networks is very similar to the processing for large cells in synchronous networks, the only difference being that the search interval is considerably larger, in order to cover a frame length (the preamble is sent every frame at fixed positions in a periodic fashion), as shown in FIG. 9 and in FIG. 10. Consequently, since the processing is done on a large number of symbols, in order to use a reasonable amount of memory, the processing maybe done in real-time using the memory 123 as a buffer or as a FIFO, and a smaller number of preambles may be processed in a multiplexed fashion. This is possible because of the reduced complexity of the L-point IFFT compared to the N-point FFT. During the processing of the N-point FFT, more than NIL preambles may be processed (more than four in the preferred application).

It has been shown that the proposed device is capable of scanning for neighbor base stations in all types of deployments. However, an embodiment of the proposed invention is flexible enough to accommodate other functions like soft combining for macro-diversity, multiple receive chains, etc. Other functions may be accommodated by combining the basic functions described in an embodiment of invention.

Using the aforementioned functions in reversed order, the power up strategy becomes evident. Due to the low complexity, a fast power-up is possible. First, a cell search is performed (using scanning for asynchronous networks for a subset of the preambles and for a given frequency offset hypothesis). The preambles detected are further analyzed with a 3-symbol acquisition window (using scanning for synchronous networks, large cells).

If successful, the frame structure is established and the receiver enters the steady-state tracking mode (optionally synchronous scan for small cells may be used to select the best base station).

Once the receiver is in tracking mode, it may immediately continue scanning in order to find a better base station. At any time, the scanning may be done in parallel with normal data reception in a seamless fashion.

Those skilled in the art may imagine different power-up strategies and different functions for the described apparatus, without departing from the spirit and scope of the present disclosure.

Thus, using the aforementioned techniques, a comprehensive set of techniques is provided to ensure timing synchronization from power-up to functional steady-state timing tracking. Furthermore, using these techniques, all types of scanning may be available and therefore they may be used in all type of deployments, for example in mobile point-to-multipoint applications deployed in a cellular network.

The low complexity of the algorithms yields the low power consumption in mobile applications, allowing for instance portable terminals with reasonable battery autonomy. The scanning may be done quickly and during the data reception, minimizing the need for special scanning intervals, and hence allowing the mobile station to sleep more in order to conserve its power. In addition, a reasonable time for power-up to operational state (in order of seconds) is possible, and when service interruption occurs due to very harsh conditions, a quick recovery is possible.

An application is the OFDMA physical layer based on a 1024 point FFT of the IEEE 802.16 standard.

An embodiment of this invention applies (but it is not limited) to mobile stations.

Therefore, an embodiment of the invention offers:

a simple algorithm for steady-state timing tracking, which includes a correlation with an expected training sequence, carried out in the frequency domain and then transformed back to time domain, where the channel impulse response may be discriminated from the noise. One advantage is that all of the processing is done using discrete sets of samples by evaluating only the FFT result of fixed FFT windows spaced by the nominal cyclic prefix. Hence, a lot of the processing may be shared with a demodulator, and parallel processing is possible;
a computationally efficient scanning for synchronous scanning in small cells (that is to say in the case where training sequences are synchronous among base stations of the network and the search domain is not far from the training sequence of the serving base station, using only one OFDM symbol for the detection), by using a specific scheduling of the functional module. Notably, it may seamlessly be done during normal operation;
a computationally efficient scanning for synchronous scanning in large cells (that is to say in the case where the search domain is larger, using for example one OFDM symbol before and one OFDM symbol after the symbol containing the training sequence of the serving base station for the detection), by scheduling the functional module to run a first detection over the symbol before and the symbol containing the training sequence of the serving base station, and a second detection over the symbol containing the training sequence of the serving base station and the symbol after, and the choosing the best result of the detections; and
an efficient scanning for power-up cell search or for scanning asynchronous base stations during normal operation, by using the processing over two OFDM symbols and extending the interval to the known length of frame.

Therefore a comprehensive set of methods is provided to ensure timing synchronization from power-up to functional steady-state timing tracking, and all types of scanning are available and can be used in all type of deployments.

What is claimed is:

1. Device for processing at least an incoming signal in a wireless communication system, said incoming signal being sent by a base station and comprising successive frames, each of which comprising at least a training symbol or preamble correlated to said base station, and a data symbol carrying message data, characterized in that said device comprises at least:
a first module digitizing and sampling the incoming signal;
a second module demodulating said digitized and sampled incoming signal, and generating a corresponding frequency domain symbol;
a timing synchronization and scanning module suitable for detecting at least a time offset of said training symbol by using said corresponding frequency domain symbol; and
a timing post processing module for processing said timing offset and for generating an improved timing offset used to start the sampling of following incoming signal.

2. Device according to claim 1, wherein said timing synchronization and scanning module is suitable for processing, based on commands from a control module, a plurality of training symbols sent at least by a serving base station and a neighbour base station, and providing timing offset and signal quality measurement of each training symbol to the control module, only the timing offset corresponding to the training symbol correlated to the serving base station are sent to the timing post processing module.

3. Device according to claim 1, wherein said timing synchronization and scanning module comprises at least:
a frequency domain correlation module controlled by the control module, for computing and generating at least a channel impulse response based at least on the frequency domain symbol corresponding to said training symbol correlated to the serving base station;
a preamble processing module for determining if a specific preamble is present in said incoming signal, for generating a detection decision and for estimating the timing offset;
a statistic processing module for sending at least the detection decision, and the timing offset to said control module, and for sending said timing offset of said training symbol corresponding to said serving base station to the timing post processing module.

4. Device according to claim 3 wherein said frequency domain correlation module comprises at least:
a look-up table module containing at least an inverse of preambles,
a deconvolution module multiplying the frequency domain symbol with the inverse of the preamble as generated by the look up table,
a third module transforming the result of the multiplication in time domain,
a windowing module multiplying the result of the deconvolution module with a windowing function to eliminate the distortions caused by discontinuities.

5. Device according to claim 3, wherein said preamble processing module comprises at least:
a discriminator suitable for differentiating between the useful part of the input channel impulse response and a noise floor and for outputting a discriminated channel impulse response,
means for computing a timing offset from the discriminated channel impulse response.

6. Device according to claim 5, wherein said discriminator generates the power of the channel impulse response when the power of the said channel impulse response is above a predetermined threshold, and generating a zero when the power of the channel impulse response is below the threshold.

7. Device according to claim 5, wherein said preamble processing module is further capable of jointly processing at least two channel impulse responses corresponding to at least two successive symbols.

8. Device according to claim 7, wherein the said preamble processing module is further capable to compute a metric for each of the two discriminated channel impulse responses corresponding to successive symbols.

9. Device according to claim 8, wherein said preamble processing module selects and discriminates the useful taps for both channel impulse responses by using the discriminated channel impulse response which has the highest metric amongst the two metrics.

10. Device according to claim 5, wherein the timing offset is computed as an average delay of the discriminated channel impulse responses.

11. Method for implementing a device according to claim 1, in a timing tracking of a serving base station mode, comprising at least the steps of:
sending to the timing synchronization and scanning module at least:
an index of an expected preamble in said incoming signal,
an index of a frequency domain symbol corresponding to the expected preamble, and
a decimation factor, and
a decimation offset,
said timing synchronization and scanning module executes the steps of:
generating a frequency domain symbol corresponding to said incoming signal,
detecting a time offset of said training symbol by using said frequency domain symbol,
sending a detection decision according to the expected preamble, and
sending said timing offset to said timing post processing module,
said timing post processing module executed the steps of:
generating an improved timing offset, and
establishing a sampling instant for following incoming signal.

12. Method according to claim 11, wherein, in a scanning for neighbor base stations in synchronous networks mode, it further comprises at least the steps of:
sending to the timing synchronization and scanning module at least:
a list of indexes of expected preambles in said incoming signal,
an index of frequency domain symbols corresponding to the expected
preambles,
a decimation factor, and
a decimation offset,
said timing synchronization and scanning module executes at least the steps of:
generating a frequency domain symbol corresponding to said incoming signal,
detecting timing offsets of said training symbols by using said frequency domain symbol,
providing at least a set, said set comprising at least:
an index of an expected preamble among the list of indexes of expected preambles,
a corresponding detection decision according to said expected preamble of the set,
a corresponding timing offset,

13. Method according to claim 11, wherein, in a scanning for neighbor base stations in synchronous networks with large cells mode, it further comprises at least the steps of:
sending to the timing synchronization and scanning module at least:
a list of indexes of expected preambles,
an index of the first frequency domain symbols where the preambles are going to be searched in the incoming signal,
a number of frequency domain symbols where the preambles are going to be searched in the incoming signal,
a decimation factor, and
a decimation offset,
the timing synchronization and scanning module executes at least the steps of:
generating frequency domain symbols corresponding to said incoming signal,
detecting timing offsets of said training symbols by using said frequency domain symbols,
providing at least a set, said set comprising at least:
an index of an expected preamble among the list of index of expected preambles,
a corresponding detection decision according to said expected preamble of the set,
a corresponding timing offset,

14. Method according to claim 13, wherein, in a scanning for neighbor base stations in asynchronous networks mode, the number of frequency domain symbols where the preambles are going to be searched is equal to or greater than the number of symbols in a frame.
